(19) United States
(12) Patent Application Publication
(10) Pub. No.: US 2025/0283708 A1
(43) Pub. Date: Sep. 11, 2025

(54) INDUCTION ANNEALING APPARATUS

(71) Applicant: AMP Annealing Limited, Pukekohe (NZ)

(72) Inventors: Alexander Findlay, Pukekohe (NZ); Matthew Findlay, Pukekohe (NZ); Geoffrey Michael Causley, Auckland (NZ)

(73) Assignee: AMP Annealing Limited, Pukekohe (NZ)

(21) Appl. No.: 19/076,460

(22) Filed: Mar. 11, 2025

Related U.S. Application Data
(60) Provisional application No. 63/563,636, filed on Mar. 11, 2024.

(51) Int. Cl. F42B 33/10; C22F 1/08; H01F 27/24; H01F 27/28; H05B 6/06; H05B 6/10; H05B 6/40

(52) U.S. Cl. CPC F42B 33/10; H01F 27/24; H01F 27/28; H05B 6/06; H05B 6/103; H05B 6/40; C22F 1/08

(57) ABSTRACT

An apparatus for induction annealing an object is disclosed. The apparatus comprises an induction coil for heating at least a portion of the object and an alternating current source electrically connected or selectively connectable to the induction coil. The apparatus further comprises a light sensor and a controller. The controller controls the time during which the object is heated by the induction coil based on detection, by the light sensor, of visible and/or near-visible infrared light emitted by the object.

### CROSS-REFERENCE TO RELATED PATENT APPLICATIONS

This application is based on and claims priority to U.S. Provisional Patent Application 63/563,636, filed Mar. 11, 2024, the entire contents of which is incorporated by reference herein as if expressly set forth in its respective entirety herein.

### FIELD OF THE TECHNOLOGY

The present invention relates to induction annealing, and in particular to an apparatus, system or method for automatically controlling annealing temperatures.

### BACKGROUND TO THE TECHNOLOGY

Firing and reloading of brass cartridges causes the alloy to become brittle around the neck of the cartridge case (sometimes simply known as “brass”). In order to reuse brass cartridge cases, it is beneficial to first anneal the neck. Annealing is the process of heating a metal to near its recrystallisation or melting point and allowing it to cool to allow the crystals to reform in a more optimal manner for reuse. Inductive heating can be used to transfer sufficient energy to the brass neck to cause the required heating. Apparatus suitable for inductive annealing of brass cartridge cases are disclosed in U.S. Pat. Nos. 9,631,251 and 10,876,191, the contents of which are incorporated by reference in their entirety.

Annealing of cartridge cases requires precise control of the heat applied. Insufficient heat application results in insufficient temperature in the target area and no annealing effect. Excessive heat may destroy the case. The heat application must also be localised to the neck and shoulder of the case. Therefore, heat must be applied quickly to the target area in a process called flash annealing.

Inductive annealing is subject to a number of variables that can impact on the annealing process. These variables include the dimensions and material composition of the case, the magnetic coupling between the inductive heating apparatus and the neck, and the mass of brass to be annealed. There are a large number of different types of brass case and calibrating the inductive heating apparatus for each is labour intensive.

Furthermore, some users may put cases from a number of different manufacturers in the same batch to be annealed. For example, the user may pick up assorted sizes of brass at a range, sort the cases by calibre, and then reload cartridges having the same calibre in a single batch. Very often, after being sorted by calibre, these batches include cases made by multiple manufacturers. The required anneal times of the various cases may vary by more than 80%.

One solution to this problem is described in U.S. Pat. No. 11,209,375, the contents of which are incorporated by reference in their entirety. In this solution, a parameter of a magnetic circuit coupled to the object is monitored during the annealing process, for example the resonant frequency of an electromagnetic circuit comprising a coil and a magnetically permeable core. A significant change in the parameter indicates a material transition point, for example a melting point, of the object being annealed. From the material transition point, an annealing parameter, for example an annealing time, is determined that is suitable for annealing similar objects. One downside of this process is that one sample (or “sacrificial”) case of each case type must be melted to determine a suitable annealing parameter for similar cases.

Objects at a temperature greater than 0 degrees Kelvin (absolute zero) emit thermal (electromagnetic) radiation. It is possible to estimate the temperature of a given object based on the frequency and intensity of this radiation. However, two objects at the same temperature may emit different amounts of radiation depending on their “emissivity”. Emissivity may depend on factors such as the chemical composition of the body and its surface finish. Therefore, detection of such radiation may be unsatisfactory for accurately determining the temperature of a plurality of non-identical objects unless the emissivity of each object is known.

### OBJECT OF THE TECHNOLOGY

It is an object of the technology to provide an annealing apparatus which automatically controls the heating of the object to be annealed.

It is an another object of the technology to provide an apparatus which can automatically sort different a plurality of cartridge cases into a plurality of groups.

Alternatively, it is an object of the technology to at least provide the public with a useful choice.

### SUMMARY OF THE TECHNOLOGY

According to one form of the present technology there is provide an apparatus for induction annealing an object, the apparatus comprising:
an induction coil for heating at least a portion of the object;
an alternating current source electrically connected or selectively connectable to the induction coil;
a light sensor; and
a controller,
wherein the controller controls the time during which the object is heated by the induction coil based on detection, by the light sensor, of visible and/or near-visible infrared light emitted by the object.

According to another form of the technology there is provided an apparatus for induction annealing an object, the apparatus comprising:
an induction coil for heating at least a portion of the object;
an alternating current source electrically connected or selectively connectable to the induction coil;
a light sensor; and
a controller,
wherein the controller controls the time during which the object is heated by the induction coil based on the formula:

T=T_{D}+C+k T_{D}
where:
T is the total time during which the case is heated by the induction coil;
T_{D} is the time required for the object to reach Draper point incandescence;
C is a predetermined constant; and
k is a predetermined coefficient.

Preferably, the controller disconnects the alternating current source from the induction coil at the end of time T.

Preferably, the controller causes the object to move out of the magnetic field generated by the induction coil at the end of time T.

Preferably, the apparatus comprises a magnetically permeable core and the induction coil is wound around the magnetically permeable core, wherein the magnetically permeable core has a first end and a second end separated by an air gap.

Preferably, the apparatus comprises a holder for holding the object in the air gap.

Preferably, the object is a cartridge case and the holder is configured to hold the neck of the cartridge case in the air gap.

Preferably, the holder is controllable by the controller to release the object.

Preferably, the object moves out of the magnetic field under the influence of gravity when the holder releases the object.

According to another form of the technology there is provided a controller-implemented method for induction annealing an object, the method comprising:
controlling a power supply controller to deliver an alternating current to an induction coil;
monitoring data from a light sensor positioned to sense visible and/or near visible infrared light emitted by the object when the object is positioned in an alternating magnetic field generated by the induction coil to anneal the object; and
controlling the power supply controller to cease delivering the alternating current to the induction coil when the data indicates that an amount of light sensed by the light sensor exceeds a threshold.

Preferably, the method comprises controlling the power supply controller to cease delivering the alternating current to the induction coil when the data indicates that the object is incandescent in the visible spectrum.

According to another form of the technology there is provided an apparatus for sorting a plurality of cartridge cases into a plurality of groups, the apparatus comprising:
A plurality of containers;
A detector configured to detect which of the plurality of groups a selected cartridge case belongs to; and
a container selector configured to select which of the plurality of containers the selected cartridge case moves to based on information from the detector.

Preferably, the detector comprises:
an induction coil for heating at least a neck portion of the cartridge case;
an alternating current source electrically connected or selectively connectable to the induction coil;
a light sensor; and
a controller,
wherein the controller determines which of the plurality of groups the individual cartridge case belongs to based on the time required to heat the cartridge case until the light sensor detects that the cartridge case is incandescent.

Preferably, the container selector comprises a movable chute.

Preferably, the container selector comprises a movable platform and the controller controls the moveable platform such that the relevant container is moved into position to receive the cartridge case.

According to one aspect of the technology there is provided an apparatus for induction annealing an object, the apparatus comprising:
an induction coil;
a power supply controller for connecting the induction coil to an alternating current source;
a light sensor for sensing light emitted by the object when the object is positioned in an alternating magnetic field generated by the induction coil to anneal the object,
wherein the power supply controller is configured to disconnect the induction coil from the alternating current source when an intensity of light sensed by the light sensor reaches or exceeds a threshold.

Preferably, the light sensor comprises a camera for imaging the object when the object is placed in the magnetic field generated by the induction coil.

Preferably, the power supply controller is configured to disconnect the induction coil from the alternating current source when the light sensed by the light sensor indicates that the object is incandescent in the visible spectrum.

Preferably, the apparatus comprises a magnetically permeable core and the induction coil is wound around the magnetically permeable core.

Preferably, the magnetically permeable core has a first end and a second end separated by an air gap.

Preferably, the apparatus comprises a holder for holding the object in the air gap.

Preferably, the object is a cartridge case and the holder is configured to hold the neck of the cartridge case in the air gap.

According to another aspect of the technology, there is provided a controller-implemented method for induction annealing an object, the method comprising:
controlling a power supply controller to deliver an alternating current to an induction coil;
monitoring data from a light sensor positioned to sense light emitted by the object when the object is positioned in an alternating magnetic field generated by the induction coil to anneal the object; and
controlling the power supply controller to cease delivering the alternating current to the induction coil when the data indicates that an amount of light sensed by the light sensor exceeds a threshold.

Preferably, the method comprises controlling the power supply controller to cease delivering the alternating current to the induction coil when the data indicates that the object is incandescent in the visible spectrum.

According to another aspect of the technology, there is provided an apparatus for induction annealing an object, the apparatus comprising:
an electromagnet for generating an alternating magnetic field for induction annealing the object when the object is positioned in the magnetic field;
a controller for supplying electrical power to the electromagnet; and
a light sensor for sensing light emitted by the object when the object is being induction annealed,
wherein the controller is configured to cease supplying electrical power to the electromagnet when an amount of light sensed by the light sensor exceeds a threshold.

According to another aspect of the technology there is provided an apparatus for induction annealing an object, the apparatus comprising:
an induction coil connected or connectable to an alternating current source;
a light sensor for sensing light emitted by the object when the object is positioned in an alternating magnetic field generated by the induction coil to anneal the object, and
a controller configured to cause the object to move out of the alternating magnetic field when an intensity of light sensed by the light sensor reaches or exceeds a threshold.

Preferably, the apparatus comprises a holder for holding the object within the magnetic field, wherein the holder is controllable by the controller to release the object.

Preferably, the object moves out of the magnetic field under the influence of gravity when the holder releases the object.

Further aspects of the technology, which should be considered in all its novel aspects, will become apparent to those skilled in the art upon reading of the following description which provides at least one example of a practical application of the technology.

### BRIEF DESCRIPTION OF THE DRAWINGS

One or more embodiments of the technology will be described below by way of example only, and without intending to be limiting, with reference to the following drawings, in which:

FIG. 1 is an isometric view of an induction annealing apparatus of the present technology, with part of an outer housing removed.

FIG. 2 is a schematic diagram of a system for induction annealing a neck of a cartridge case according to one form of the technology.

FIG. 3 is a flow chart of one method of annealing a cartridge case according to one form of the technology.

FIG. 4 is a flow chart of another method of annealing a cartridge case according to one form of the technology.

FIG. 5 is a partial view of an internal structure of another sorting/annealing apparatus of the present technology.

### BRIEF DESCRIPTION OF EXEMPLARY FORMS OF THE TECHNOLOGY

In general terms, forms of the technology are based on a principle identified by the inventors, which is that, when annealing certain objects (in particular brass cartridge cases), a suitable point of time to cease the process of annealing the object may be determined by monitoring for a change in the light emitted by the object, for example the visible light emitted by the object (or light in the near-visible infrared range). In certain examples, for example when the object is a brass cartridge case, a suitable point of time to cease the annealing process may be when the object begins to incandesce in the visible spectrum (the so-called Draper point), or this may be used as a reference point to calculate a required anneal time.

### 1.1. Induction Annealing Apparatus

Forms of the technology comprise an induction annealing apparatus 100. The apparatus 100 may be substantially similar to that described in U.S. Pat. Nos. 9,631,251, with the addition of a light sensor and a suitable controller, as described further below.

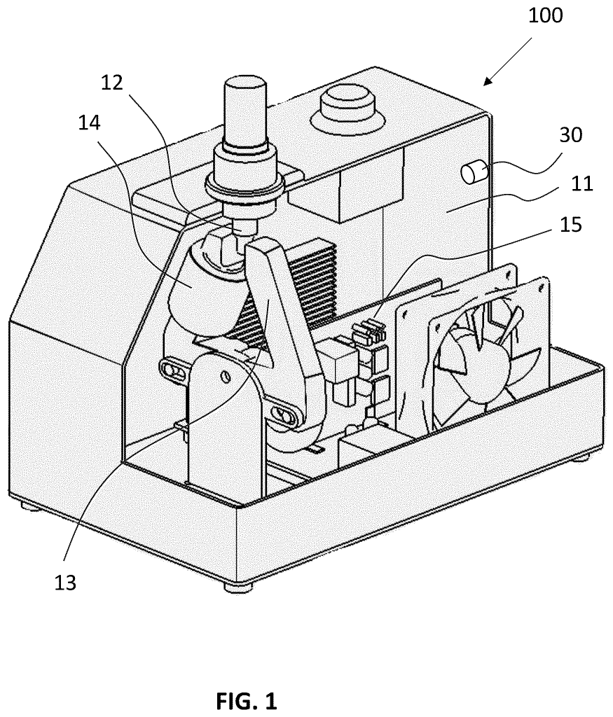

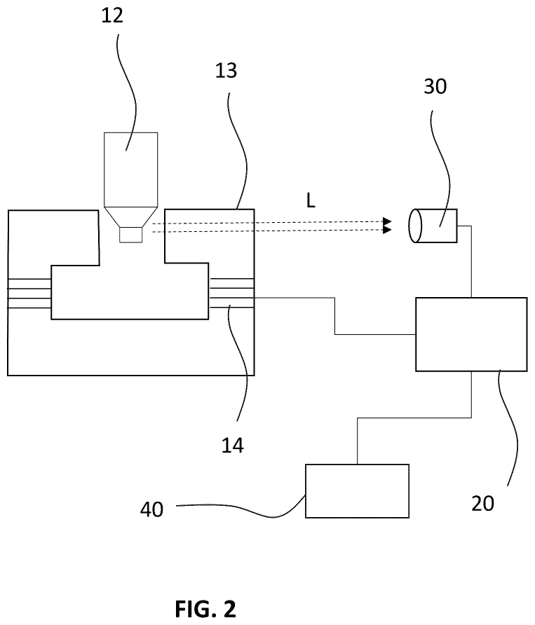

Referring first to FIGS. 1 and 2, in one form, the induction annealing apparatus 100 comprises a housing 11 within which many of the components of the apparatus are housed.

Inside housing 11 is a magnetic core 13 which defines an air gap between two ends of the core. Around the magnetic core 13 is wound an induction coil 14, which comprises one or more windings of electrically conducting material such as Litz wire. The induction coil 14 can be electrically connected to an alternating current power source 40 such that, when energised, an alternating magnetic field is induced in the magnetic core 13 and across the air gap between its ends.

The apparatus 100 comprises a holder for a cartridge case 12 in which the case can be positioned so that the neck of the case is positioned in the air gap defined by the ends of magnetic core 13. In the embodiment of FIG. 1, the case holder comprises a hole in housing 11 into which the case 12 may be inserted and held in the desired place.

It may be generally desirable for the air gap between the ends of the magnetic core 13 to be as small as possible whilst still being large enough for the case to be annealed to fit inside the gap without touching the magnetic core. The larger the air gap, the longer the annealing process takes and the higher the risk that parts of the case other than the neck may be annealed and softened. The magnetic core 13 may therefore be configured with an air gap suitable for a range of cartridges or, in some examples, the size of the air gap between the ends of the magnetic core 13 may be able to be adjusted to accommodate cartridge cases having differing diameter necks.

The apparatus 100 further comprises one or more controllers 20 for controlling the operation of the apparatus and its components. The controller may be embodied in any suitable manner, for example it may take the form of control circuitry 15. For the purposes of this specification, the functional capabilities of the apparatus will be described without detailed reference to the components used to implement those capabilities. Those skilled in the art will appreciate that the functionality of induction annealing apparatuses according to forms of the technology may be implemented using any appropriate electronic hardware componentry, through computer software executed by one or more processors or controllers (e.g. a Field Programmable Gate Array (FPGA)), or a combination of both.

The apparatus further comprises a light sensor 30 which is in communication with one or more of the controllers 20. The light sensor is provided within the housing 11 and is preferably located such that light L radiating from the case 12, in particular from the neck of the case 12, has a direct path to the sensor 30. In alternative examples (not shown), the light sensor 30 may be provided within the housing 11 in a position such that there is no direct path for light to travel from the neck of the case 12 to the sensor 30. In such examples it may be necessary to provide a reflective element within the housing 11 to reflect light (either specular or diffuse) from the case 12 to the sensor 30. The reflective element may be one or more mirrors or prisms, for example. In examples, the interior of the housing 11 may be substantially sealed from environmental or ambient light, or at least the light sensor 30 may be shielded from detecting environmental or ambient light.

In examples, the target temperature for the neck of the case 12 is a peak of approximately 550° C. (approximately 1022° F.). At this temperature, brass emits electromagnetic radiation in both the visible spectrum (e.g. as an orange/red “glow”, which may be described as incandescence) and the infrared spectrum (all such radiation referred to herein as “light”, whether in the infrared or visible spectrum, unless stated otherwise or unless the context clearly requires otherwise), with the majority of the light being in the infrared spectrum. Accordingly, in some forms the light sensor 30 may be sensitive to visible light, in some forms the light sensor 30 may be sensitive to infrared light, and in some forms the light sensor 30 may be sensitive to visible and infrared light.

However, as is noted above, light intensity in the infrared spectrum may vary from object to object depending on its emissivity. Emissivity can be affected by features such as surface finish (e.g. roughness) and colour. Accordingly, in preferred examples of the invention the light sensor 30 detects light in the visible spectrum and/or near visible infrared, e.g. to detect that the cartridge case (or at least the relevant portion of the case) has reached a temperature of 525° C. (977 F), e.g. the Draper point. The term “near visible infrared” is used herein to denote non-visible light frequencies having wavelengths of no more than 780 nm.

In one example, the light sensor 30 may be a basic photodetector such as a photodiode. In other examples, the light sensor 30 may be a more complex sensor such as a Charge-Coupled Device (CCD) sensor or a CMOS sensor. In some examples, the light sensor 30 may be a digital camera which captures an image of the case 12. In such cases, the controller 20 may perform image processing on the image captured by the sensor to determine when the threshold light intensity has been reached or exceeded (for example, when the case begins to glow). In some examples, the controller may determine that incandescence has been detected only if the relevant light sensor signal persists for more than a threshold time (e.g. to filter noise).

### 1.2. Methods of Operation

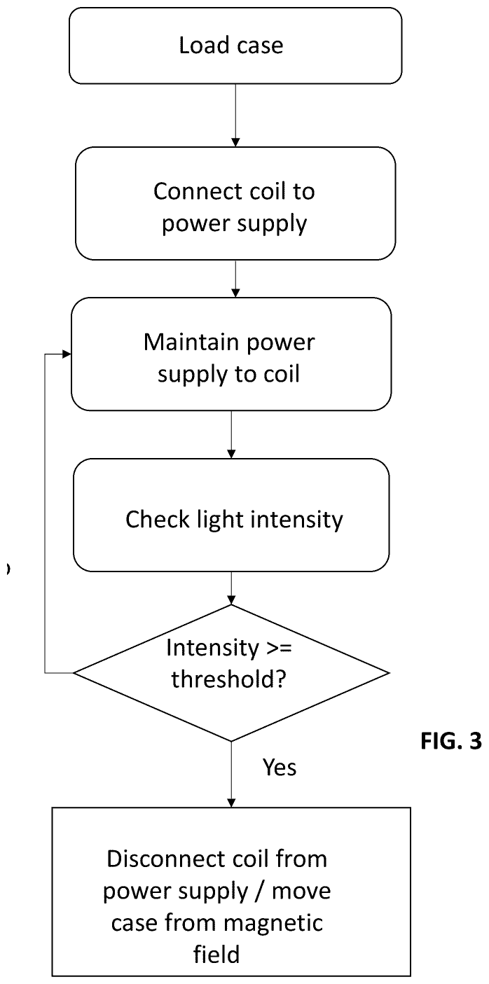

Referring next to FIGS. 2 and 3, with the case 12 in position in the air gap between the ends of the magnetic core 13, the controller 20 energises the coil 14. The light sensor 30 may continuously, or at least periodically, monitor the intensity of the light emitted by the case 12. In some examples, when the light sensor 30 detects a light intensity in a predetermined frequency or frequency range which corresponds to a temperature of 550° C. or higher the controller 20 may disconnect the magnetic coil 14 from the power source 40 so that the case 12 is not heated any further and begins to cool.

In some examples where the sensor 30 is only capable of detecting visible light, the threshold intensity of the light may be the minimum light intensity detectable by the sensor 30. However, since the brass will emit infrared light at temperatures lower than 550° C., the threshold intensity for an infrared detecting sensor may be higher than for a visible light sensor.

In some examples, the determination of whether the intensity of light has reached or exceeded the threshold may be performed by the light sensor 30, while in other examples the determination may be performed by the controller 20. Furthermore, the determination may be made on all or on a part of the detected spectrum of light. In the latter case, the light sensor 30 may be capable of detecting a spectrum of wavelengths and the light sensor 30 or the controller 20 may be configured to analyse the light detected by the light sensor 30 to determine whether the intensity of light in a part of the spectrum reaches or exceeds a threshold. As an example, the light sensor 30 may be capable of detecting both visible and infrared light but the determination of whether the threshold has been met or exceeded may be made only on the visible light, or on only the infrared light. In other examples the determination of whether the threshold has been met or exceeded may be based on both visible light and infrared (preferably near-visible infrared) light frequencies.

In some forms of the technology, rather than disconnecting the magnetic coil 14 from the power source 40 when the case has been heated to the required temperature, the controller 20 may instead take an action which results in the case 12 moving out of the alternating magnetic field when the threshold temperature is reached. For example, the holder may be configured to release the case 12 when annealing is complete, thereby allowing the case 12 to move, for example under the influence of gravity, to a position below the induction coil 14. In other examples, the holder may be configured to move between one position in which the case 12 is in the magnetic field and another position in which the case 12 is out of the magnetic field. In some such examples the magnetic coil 14 may remain connected to the power source 40 while further cases are loaded into the holder.

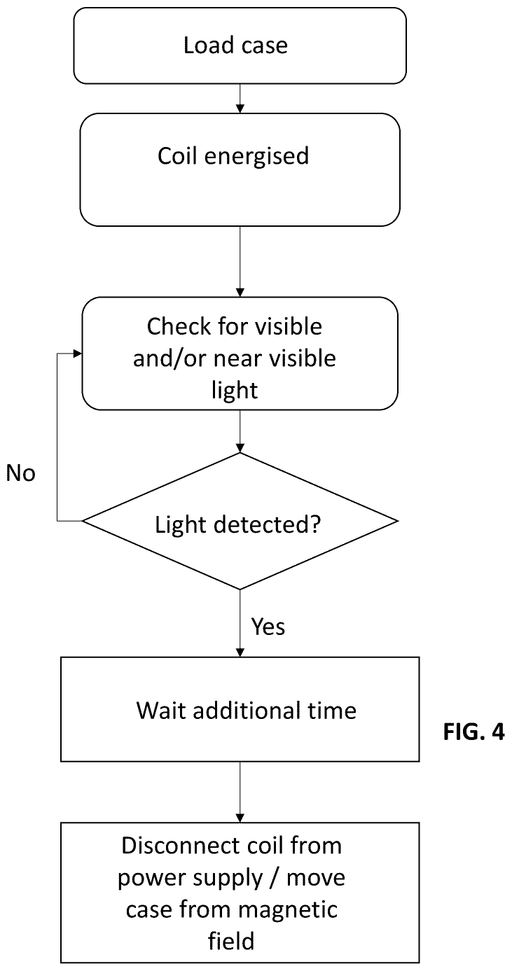

In some examples of the invention, the apparatus may detect when the cartridge case begins to visibly glow at the Draper point. For almost all materials this occurs at a temperature of 525° C. (977 F). Since this is lower than the 550° C. (1022 F) optimum temperature for annealing, the controller may operate to cause continued heating of the case beyond detection of the Draper point incandescence (see. FIG. 4). The additional time may be a predetermined time. In another example, the additional time may be calculated based on the time taken for the case to begin to glow.

In some examples the additional time may comprise a constant and a factor derived from the time required to reach the Draper point, e.g.

T=T_{D}+C+k T_{D}

Where:
T is the total time during which the case is heated by the induction coil.
T_{D} is the time required to reach the Draper point incandescence.
C is a predetermined constant.
k is a predetermined coefficient.

In examples, C may be between 0 and 1 second (inclusive).

In examples, k may be between 0 and 0.1 (inclusive).

Other ways of determining the additional time may also be used.

At the end of time T the controller 20 may disconnect the magnetic coil 14 from the power source 40 and/or the controller 20 may take an action which results in the case 12 moving out of the alternating magnetic field.

In some examples it may not be necessary to continue energising the induction coil once the Draper point has been detected. In examples, the apparatus may have sufficient heat capacity that the temperature of the case continues to increase for a short time after the magnetic coil ceases to be energised. This may be sufficient to heat the case to substantially 550° C. (or an alternative required temperature). Alternatively, it may be acceptable to heat the case to only the Draper point temperature.

### 1.3. Sorting Cases

There may be some variation in the heating time required for different cases to reach the Draper point. This may be caused by, for example, differences in the mass, the wall thickness or geometric differences between the cases. Accordingly, the time taken to reach the Draper point may be a useful way of sorting cases, and the induction apparatus may function as a detector for detecting the different types of case.

In one form of the invention, the user may anneal a randomly selected subset of cases from the bulk of cases they wish to sort. Annealing this subset of the cases allows an overall range of times required to reach the Draper point to determined. This total range of times may be divided into a plurality of subranges. The subranges may be selected such that a substantially equal number of the cases fall within each subrange, or they may be selected such that the number of cases is unequally distributed between the subranges.

### Examples Include:

Division of the anneal times into two equal subranges (e.g. an upper subrange and a lower subrange).
Division of the anneal times into three or more subranges, where a substantially equal number of the cases falls within each of the subranges.
Division of anneal times into a main subrange and upper and lower subranges, where the number of the cases falling within the upper and lower subranges is significantly smaller than the number falling within the main subrange, such that the upper and lower subranges represent outliers.
Division of the anneal times into a number of subranges equal to the number of different types of cases in the bulk lot of cases, where each subrange represents a different type of case.

In some forms of the technology the apparatus may be able to physically sort the cartridge cases into different physical zones or containers depending on the time taken to reach the Draper point for each case. In some such examples, each zone or container may be representative of one subrange of times, as set out above. In other examples, one or more of the containers or zones may be representative of a plurality of the subranges (e.g. all cases other than a selected type of case). This may, for example, allow automatic sorting of different brands or types of cartridge case, or sorting of a single type of case into groups having similar characteristics.

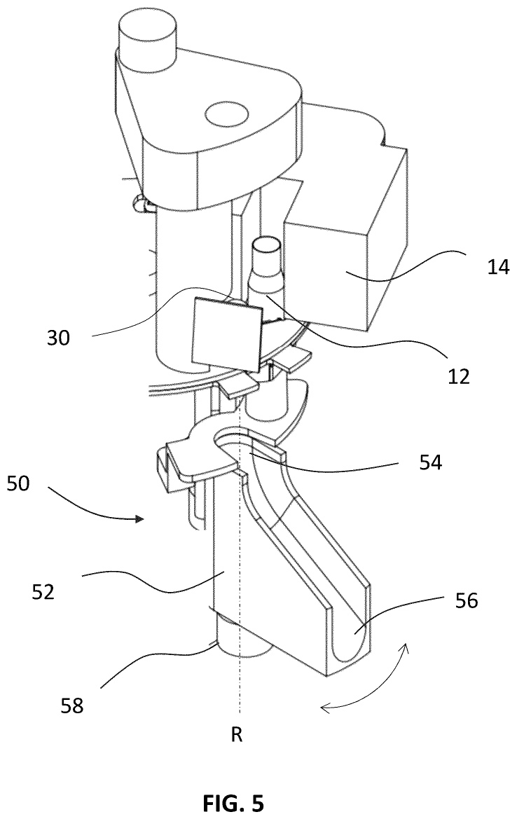

Referring next to FIG. 5, a partial view of an internal structure of a sorting apparatus is shown. The sorting apparatus comprises a detector comprising an annealing apparatus comprising a light sensor 30, an induction coil 14 and a holder for a cartridge case 12.

The sorting apparatus comprises a container selector 50. The container selector 50 determines which container or zone a particular cartridge case is moved to. In the example shown, the container selector 50 comprises a chute 52 having a first end 54 and a second end 56. The chute 52 is rotatable about a rotational axis R by an actuator 58. In use, the controller controls the actuator 58 to rotate the chute 52 to a required rotational position based on information from the detector. The rotational axis R may extend through the first end of the chute 52, such that the first end 52 rotates but does not translate when the chute 52 is rotated.

The rotational position of the chute 52 is selected such that the case (once annealed) will slide down the chute 52, from the first end 54 to the second end 56, and into a selected container (not shown). In some examples, the chute 52 may be moveable to a position underneath the cartridge 12 when the detecting/annealing process is finished. In other examples, a suitable mechanism may move the cartridge case 12 to the first end 54 of the chute 52 when the detecting/annealing process is finished.

In another form of the technology a sorting apparatus may use additional and/or alternative methods of sorting cartridge cases into groups. For example, the apparatus may comprise a detector comprising one or more optical sensors configured to determine a height of each cartridge case. Alternatively, or additionally, the sorting apparatus may comprise a detector having a load sensor for determining a mass of each cartridge case.

In examples alternative container selectors may be used. For example, the sorting apparatus may comprise a plurality of chutes, each defining a path to a different container, and the apparatus may move the cartridge case to the entrance of the relevant chute, based on information from the detector.

In other examples, the containers may be positioned on a movable platform and the controller may control the moveable platform such that the relevant container is moved into position to receive the cartridge case, depending on information from the detector. The case may move down a chute to the relevant container, or may drop directly into the container from the holder.

### 1.4. Other Remarks

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The entire disclosures of all applications, patents and publications cited above and below, if any, are herein incorporated by reference.

Reference to any prior art in this specification is not, and should not be taken as, an acknowledgement or any form of suggestion that that prior art forms part of the common general knowledge in the field of endeavour in any country in the world.

The technology may also be said broadly to consist in the parts, elements and features referred to or indicated in the specification of the application, individually or collectively, in any or all combinations of two or more of said parts, elements or features.

Where in the foregoing description reference has been made to integers or components having known equivalents thereof, those integers are herein incorporated as if individually set forth.

It should be noted that various changes and modifications to the presently preferred embodiments described herein will be apparent to those skilled in the art. Such changes and modifications may be made without departing from the spirit and scope of the technology and without diminishing its attendant advantages. It is therefore intended that such changes and modifications be included within the present technology.

1. An apparatus for induction annealing an object, the apparatus comprising:
an induction coil for heating at least a portion of the object;
an alternating current source electrically connected or selectively connectable to the induction coil;
a light sensor; and
a controller,
wherein the controller controls the time during which the object is heated by the induction coil based on detection, by the light sensor, of visible and/or near-visible infrared light emitted by the object.

2. An apparatus for induction annealing an object, the apparatus comprising:
an induction coil for heating at least a portion of the object;
an alternating current source electrically connected or selectively connectable to the induction coil;
a light sensor; and
a controller,
wherein the controller controls the time during which the object is heated by the induction coil based on the formula:
T=T_{D}+C+k T_{D}
where:
T is the total time during which the case is heated by the induction coil;
T_{D} is the time required for the object to reach Draper point incandescence;
C is a predetermined constant; and
k is a predetermined coefficient.

3. The apparatus of claim 2, wherein the controller disconnects the alternating current source from the induction coil at the end of time T.

4. The apparatus of claim 2, wherein the controller causes the object to move out of the magnetic field generated by the induction coil at the end of time T.

5. The apparatus of claim 2, wherein C=0.

6. The apparatus of claim 2 wherein C is between 0 seconds and 1 second.

7. The apparatus of claim 2, wherein k=0.

8. The apparatus of claim 2, wherein k is between 0 and 0.1.

9. The apparatus of claim 2, wherein C=0 and k=0.

10. The apparatus of claim 2, wherein the apparatus comprises a magnetically permeable core and the induction coil is wound around the magnetically permeable core, wherein the magnetically permeable core has a first end and a second end separated by an air gap.

11. An apparatus as claimed in claim 10, wherein the apparatus comprises a holder for holding the object in the air gap.

12. An apparatus as claimed in claim 11, wherein the object is a cartridge case and the holder is configured to hold the neck of the cartridge case in the air gap.

13. An apparatus as claimed in claim 12, wherein the holder is controllable by the controller to release the object.

14. An apparatus as claimed in claim 13, wherein the object moves out of the magnetic field under the influence of gravity when the holder releases the object.

15. A controller-implemented method for induction annealing an object, the method comprising:
controlling a power supply controller to deliver an alternating current to an induction coil;
monitoring data from a light sensor positioned to sense visible and/or near visible infrared light emitted by the object when the object is positioned in an alternating magnetic field generated by the induction coil to anneal the object; and
controlling the power supply controller to cease delivering the alternating current to the induction coil when the data indicates that an amount of light sensed by the light sensor exceeds a threshold.

16. A controller-implemented method as claimed in claim 15, wherein the method comprises controlling the power supply controller to cease delivering the alternating current to the induction coil when the data indicates that the object is incandescent in the visible spectrum.

17. An apparatus for sorting a plurality of cartridge cases into a plurality of groups, the apparatus comprising:
A plurality of containers;
A detector configured to detect which of the plurality of groups a selected cartridge case belongs to; and
a container selector configured to select which of the plurality of containers the selected cartridge case moves to based on information from the detector.

18. The apparatus of claim 17, wherein the detector comprises:
an induction coil for heating at least a neck portion of the cartridge case;
an alternating current source electrically connected or selectively connectable to the induction coil;
a light sensor; and
a controller,
wherein the controller determines which of the plurality of groups the individual cartridge case belongs to based on the time required to heat the cartridge case until the light sensor detects that the cartridge case is incandescent.

19. The apparatus of claim 17, wherein the container selector comprises a movable chute.
